(19) United States
(12) Patent Application Publication
(10) Pub. No.: US 2022/0111994 A1
(43) Pub. Date: Apr. 14, 2022

(54) BOTTLE STORING TWO DIFFERENT TYPES OF LIQUID

(71) Applicants: Hidemi KAGEI, Chiba Pref. (JP); Mikihisa ENDO, Kanagawa Pref. (JP); Chika OOZU, Tokyo (JP); Rena KATSUMATA, Tokyo (JP); Kazuho KATORI, Chiba Pref. (JP); Yukino KIMURA, Chiba Pref. (JP); Ayano CHIBA, Kanagawa Pref. (JP); Shoma NOUZUMI, Saitama Pref. (JP); Momo NOGAMI, Tokyo (JP); Minato HARIMA, Tokyo (JP); Shuya HIGASHIDE, Chiba Pref. (JP)

(72) Inventors: Hidemi KAGEI, Chiba Pref. (JP); Mikihisa ENDO, Kanagawa Pref. (JP); Chika OOZU, Tokyo (JP); Rena KATSUMATA, Tokyo (JP); Kazuho KATORI, Chiba Pref. (JP); Yukino KIMURA, Chiba Pref. (JP); Ayano CHIBA, Kanagawa Pref. (JP); Shoma NOUZUMI, Saitama Pref. (JP); Momo NOGAMI, Tokyo (JP); Minato HARIMA, Tokyo (JP); Shuya HIGASHIDE, Chiba Pref. (JP)

(21) Appl. No.: 17/555,362

(22) Filed: Dec. 17, 2021

(51) Int. Cl. B65D 1/04; B65D 1/02; B65D 1/06; B05B 11/00

(52) U.S. Cl. CPC B65D 1/04; B05B 11/3084; B65D 1/06; B65D 1/0207

(57) ABSTRACT

A bottle includes a body having a first liquid storage having a first opening at the bottom and a second liquid storage having a second opening at the bottom, the body having a first bottom lid covering the first opening and a second bottom lid covering the second opening, and the body having a partition plate separating the first liquid storage and the second liquid storage; a mist discharging pump having a mist discharging tube, which has one end being located inside the first liquid storage and having the other end being connected to the mist discharging pump, the mist discharging pump being exposed outside of the body from the opposite side of the first bottom lid; a liquid discharging pump having a liquid discharging tube, which has one end being located inside the second liquid storage and having the other end being connected to the liquid discharging pump, the liquid discharging pump being exposed outside the body from the opposite side of the second bottom lid.

### BACKGROUND OF THE INVENTION

### 1. Field of the Invention

This invention has been made by the members of MIMURA Seminar, College of Law, Nihon Univ. as a team. The present invention relates to a bottle that can store two different types of liquids, has different discharge means, and can easily refill the liquids from its bottom, and specifically relates to a bottle, which is compact and convenient for carrying at travelling.

### 2. Description of the Related Art

In the past, when carrying two or more different types of liquid, it was necessary to carry a plurality of bottles, each of which stores different liquids, respectively. In addition, as with shampoo bottles on the market, there is usually only one way to discharge the contents of such a bottle.

Further, due to the small diameter of the refill opening of the bottle, it is difficult to refill the liquid without spilling.

As a result, when refilling method, the bottle parts had to be removed, which posed a hygiene problem.

According to the present invention, two or more liquids can be stored in one bottle, and two discharge means can be provided respectively so that the desired liquid in the bottle can be used properly for the intended purpose. At the time of refilling, each of the bottom lids can be opened widely so that the above-mentioned problem can be solved.

### SUMMARY OF THE INVENTION

A bottle includes a body having a first liquid storage having a first opening at the bottom and a second liquid storage having a second opening at the bottom, the body having a first bottom lid covering the first opening and a second bottom lid covering the second opening, and the body having a partition plate separating the first liquid storage and the second liquid storage; a mist discharging pump having a mist discharging tube, which has one end being located inside the first liquid storage and having the other end being connected to the mist discharging pump, the mist discharging pump being exposed outside of the body from the opposite side of the first bottom lid; a liquid discharging pump having a liquid discharging tube, which has one end being located inside the second liquid storage and having the other end being connected to the liquid discharging pump, the liquid discharging pump being exposed outside the body from the opposite side of the second bottom lid.

### BRIEF DESCRIPTION OF THE DRAWINGS

The above-described and other objects and features of the present invention will be apparent from the following embodiments, which are described in reference to the accompanying drawings in which:

FIG. 1 shows a perspective view of a bottle, according to the present invention; and

FIG. 2 shows an enlarged perspective view of the bottom of the bottle with one of the bottom lids open, according to the present invention.

### DETAILED DESCRIPTION OF THE PREFERRED EMBODIMENT

Preferred embodiments of the present invention are described below, together with the drawings. In each drawing, the same reference numbers indicate the same or similar components that run through all embodiments.

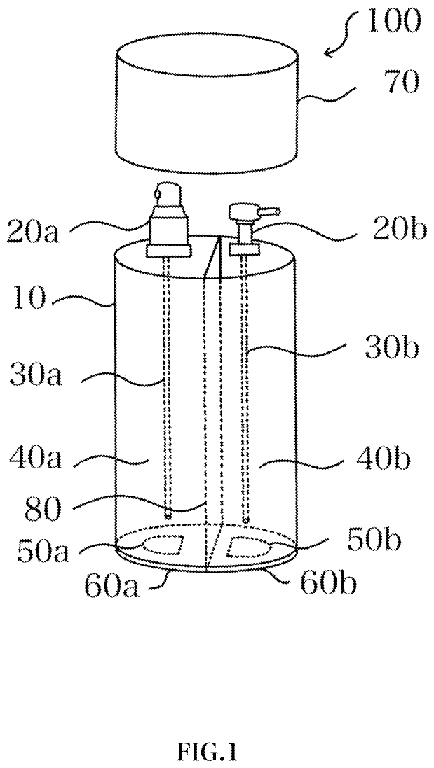

FIG. 1 shows a perspective view of a portable bottle 100, which can discharge two different liquids therein. The bottle 100 includes a cylindrical-shaped body 10, a cylindrical-shaped cap 70 coupled to one end of the body 10, a mist discharge pump 20a, and a liquid discharge pump 20b. The body 10 has a first liquid storage 40a and a second liquid storage 40b, each of which is divided by a partition plate 80. The mist discharge pump 20a includes a mist discharge tube 30a, and the liquid discharge pump 20b includes a liquid discharge tube 30b. The mist discharge tube 30a is placed inside the first liquid storage 40a at its one end, and is connected to the mist discharge pump 20a at its other end, and the liquid stored in the first liquid storage 40a is discharged from the mist discharge pump 20a to the outside of the bottle 100 in a mist state. The liquid discharge tube 30b is placed inside the second liquid storage 40b at its one end and is connected to the liquid discharge pump 20b at its other end, and the liquid stored in the second liquid storage 40b is discharged from the liquid discharge pump 20b to the outside of the bottle 100 in liquid state. The one end of the mist discharging tube 30a is placed in a position where it does not touch the bottom of the first liquid storage 40a, and the one end of the liquid discharging tube 30b is also placed in a position where it does not touch the bottom of the second liquid storage 40b. Normally, a liquid such as toner is stored in the first liquid storage 40a, and is used in a mist state. In the second liquid storage 40b, a liquid such as milk lotion is stored, and is used in a liquid state. The cap 70 is made of plastic.

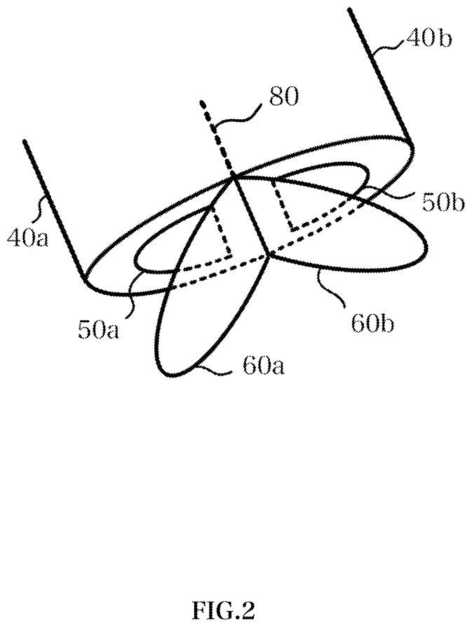

FIG. 2 shows an enlarged view of the bottom of the bottle 100. As shown in FIG. 1 and FIG. 2, the body 10 also includes a first opening 50a at the bottom of the first liquid storage 40a and the first opening is covered with an openable/closable first bottom lid 60a. The body 10 further includes a second opening 50b at the bottom of the second liquid storage 40b, and the second opening is covered with an openable/closable second bottom lid 60b. These first and second bottom lids have a strong packing material in the opening and closing portions, and there is no concern about the liquids in the first and second liquid storages 40a, 40b flowing outward from the bottom.

While each of the first and second liquid storages 40a and 40b can store the liquid up to 250 ml, respectively in the preferred invention it is recommended that the liquid should be stored with 170 ml of liquid. This is because it is possible to prevent the liquid leaking from the bottle 100 if there is sufficient room in the storages 40a, 40b.

By opening the first or second bottom lid 60a, 60b, and exposing the first or second opening 50a, 50b, it is possible that some refills can be easily injected into the first or second liquid storage 40a, 40b through the first or second opening 50a, 50b.

According to the bottle 100 of the invention, a single bottle can be used to discharge two different liquids in two different ways, and it is easy to carry around. In addition, since it is designed with hygiene in mind, the bottle 100 makes it is possible to refill the liquid without getting your hands dirty. As a result, the bottle can be refilled with liquid and can reduce resource waste. After the liquid in the bottle is used up, the user can quickly refill the bottle because of its refillable structure. Namely, it is not necessary to dispose of the empty bottle. This means that the user can save costs and protect the environment.

Furthermore, by changing the shape of the partition plate 80, it is also possible to hold three or more types of liquids. Moreover, a form spray can be used, instead of the mist discharge tube 30a, and this means that it is possible to change the discharge tube 30a, according to the intended use. Furthermore, by manufacturing the body 10 with transparent material, the remaining liquid inside the bottle 100 can be checked.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views.

Various other modifications of the illustrated embodiment will be apparent to those skilled in the art on reference to this description. Therefore, the appended claims are intended to cover any such modifications or embodiments as fall within the true scope of the invention.

We claim:

1. A bottle comprising:
a body having a first liquid storage having a first opening at the bottom and a second liquid storage having a second opening at the bottom, the body having a first bottom lid covering the first opening and a second bottom lid covering the second opening, and the body having a partition plate separating the first liquid storage and the second liquid storage;
a mist discharging pump having a mist discharging tube, which has one end being located inside the first liquid storage and having the other end being connected to the mist discharging pump, the mist discharging pump being exposed outside of the body from the opposite side of the first bottom lid;
a liquid discharging pump having a liquid discharging tube, which has one end being located inside the second liquid storage and having the other end being connected to the liquid discharging pump, the liquid discharging pump being exposed outside the body from the opposite side of the second bottom lid.

2. A bottle as claimed in claim 1 the further comprising;
a cap, which is coupled to the one end of the body, covering the mist discharging pump and the liquid discharging pump.

3. A bottle, as claimed in claim 2, wherein the body is made of transparent plastic material.

4. A bottle, as claimed in claim 3, wherein the body and the cap are formed in a cylindrical shape.

5. A bottle, as claimed in claim 1, wherein the one end of the mist discharge tube is placed in a position where it does not to touch the bottom of the first liquid storage, and the one end of the liquid discharging tube is placed in a position where it does not touch the bottom of the second liquid storage.
